(19) United States
(12) Patent Application Publication
(10) Pub. No.: US 2026/0039079 A1
(43) Pub. Date: Feb. 5, 2026

(54) COMPOSITE HAND TOOL FOR WIRE TOOLING

(71) Applicant: JETOOL CORP., New Taipei City (TW)

(72) Inventor: Yi Ching Kao, New Taipei City (TW)

(73) Assignee: JETOOL CORP., New Taipei City (TW)

(21) Appl. No.: 18/976,300

(22) Filed: Dec. 10, 2024

(30) Foreign Application Priority Data
Aug. 5, 2024 (TW) 113129145

(51) Int. Cl. H01R 43/042

(52) U.S. Cl. CPC H01R 43/0421

(57) ABSTRACT

A composite hand tool for wire tooling includes a pipe, a driving member, and a stopper. The pipe has a first port, a second port, a first window, and a second window. The first and second ports are located in a first axial direction, the first and second windows are located in a second axial direction, and the first axial direction is different from the second axial directions. The driving member is movably disposed in the pipe in the first axial direction and has a blade. The stopper is detachably assembled to the pipe to seal the first port. A first tool and a second tool are disposed on two opposite surfaces of the stopper. When the stopper is assembled to the pipe, one of the first tool and the second tool is exposed to an external environment, and the other one is hidden in the pipe.

### CROSS-REFERENCE TO RELATED APPLICATION

This application claims the priority benefit of Taiwan application serial no. 113129145, filed on Aug. 5, 2024. The entirety of the above-mentioned patent application is hereby incorporated by reference herein and made a part of this specification.

### BACKGROUND

### Technical Field

The disclosure relates to a hand tool, and in particular, relates to a composite hand tool for wire tooling.

### Description of Related Art

At present, various signal cables and signal connectors have been widely used in signal transmission. For instance, network cables and RJ45 connectors are used to transmit network signals, and telephone cables and RJ11 connectors are used to transmit telephone signals. In order to connect the wire to the required equipment, the end of the wire is connected to the corresponding connector most of the time to form a cable connector, and a specific wire crimping tool is thus needed herein to connect and fix the wire and the connector to each other.

Generally, when the cable connector is processed, relevant hand tools are required to assemble the components of the cable connector together. The currently-available hand tools for assembly are not able to integrate the components required in the process of assembling the cable connector, and there are no hand tools that offer sufficient functionality, so the processing efficiency of the user in assembling the cable connector cannot be improved accordingly.

### SUMMARY

The disclosure provides a composite hand tool for wire tooling capable of integrating the tools required for the complete process into one.

The disclosure provides a composite hand tool for wire tooling including a pipe, a driving member, and a stopper. The pipe has a first port, a second port, a first window, and a second window. The first port and the second port are located in a first axial direction, the first window and the second window are located in a second axial direction, and the first axial direction is different from the second axial direction. The driving member is movably disposed in the pipe in the first axial direction and has a blade. The stopper is detachably assembled to the pipe to seal the first port. A first tool and a second tool are disposed on two opposite surfaces of the stopper, so that when the stopper is assembled to the pipe, one of the first tool and the second tool is hidden in the pipe, and the other one of the first tool and the second tool is exposed to an external environment. A cable is adapted to extend into the pipe through the first window or the second window, and the blade cuts off an insulating outer layer of the cable to expose a plurality of core wires of the cable. The core wires are adapted to be combed by the first tool and then crimped to a connector by the second tool.

To sum up, the composite hand tool has ports and windows in different axial directions through the pipe, so that the driving member and the blade are movably disposed in the pipe. The cable can be inserted into the pipe through the windows, so that the blade can cut off the insulating outer layer of the cable. More importantly, one of the ends of the pipe is provided with the stopper, and the stopper may be assembled and disassembled relative to the pipe. Further, different tools are arranged on two opposite surfaces of the stopper, so that accordingly, when the stopper is assembled to the pipe, one of the tools is stored and the other tool is exposed, so that the user is able to perform operation accordingly. Based on the above arrangement of members, different tools can be integrated into different parts of the pipe, allowing the user to complete cable crimping and multiple previous processes through a single member and form conversion.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a composite hand tool according to an embodiment of the disclosure.

FIG. 2 is another form of the composite hand tool of FIG. 1.

FIG. 3 is an exploded view of the composite hand tool.

FIG. 4A and FIG. 4B are cross-sectional views illustrating the composite hand tool in different states.

FIG. 5A and FIG. 5B are schematic views illustrating a wire stripping process performed by the composite hand tool.

FIG. 6 is a schematic view illustrating a crimping process performed by the composite hand tool.

### DESCRIPTION OF THE EMBODIMENTS

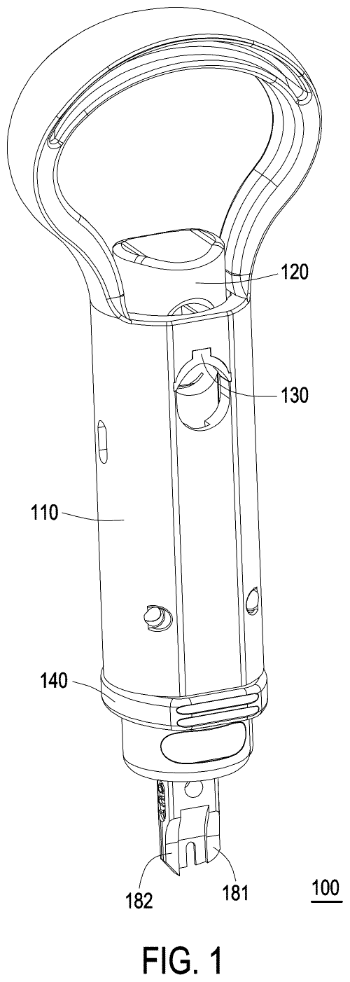

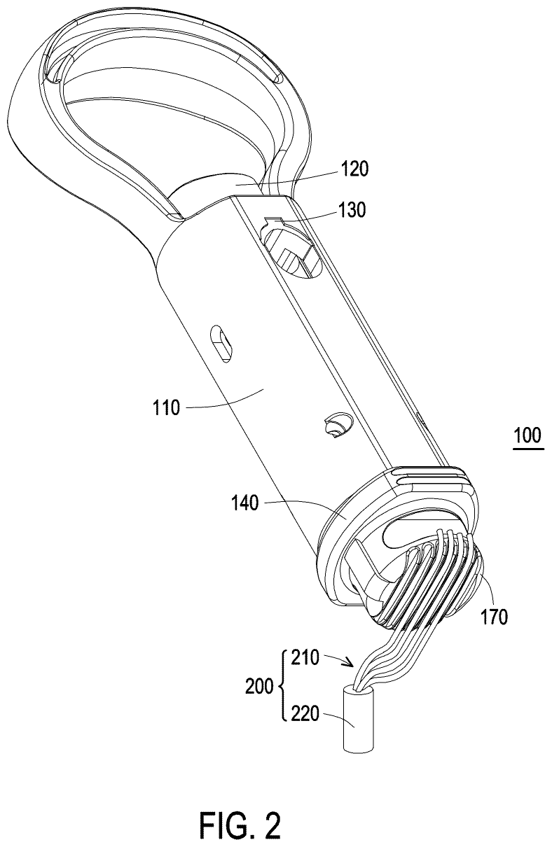

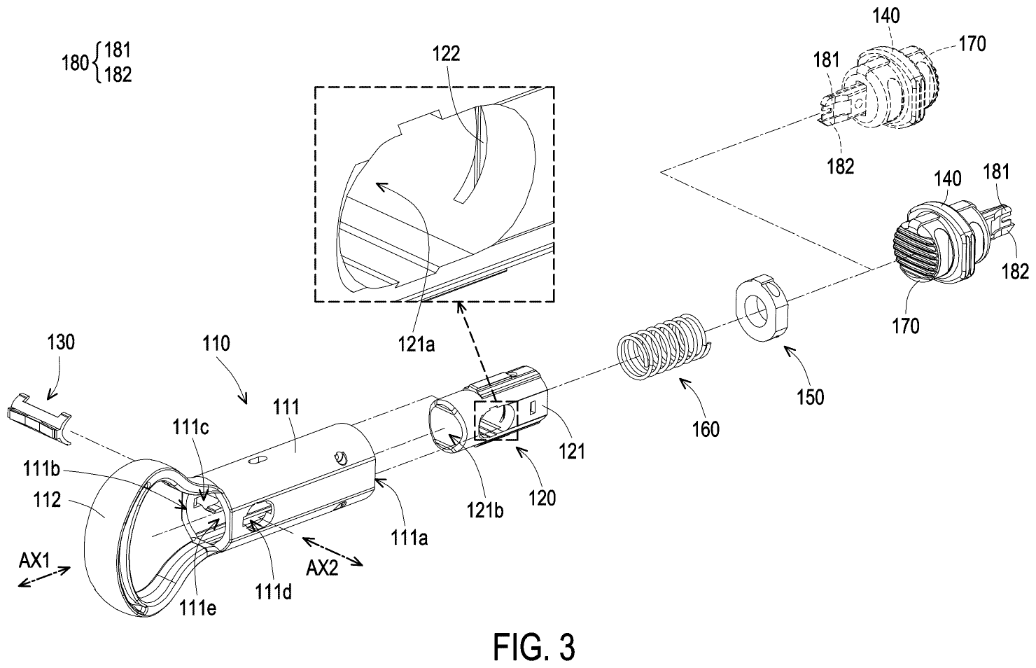

FIG. 1 is a schematic view of a composite hand tool according to an embodiment of the disclosure. FIG. 2 is another form of the composite hand tool of FIG. 1. FIG. 3 is an exploded view of the composite hand tool. With reference to FIG. 1 to FIG. 3 together, in this embodiment, a composite hand tool for wire tooling 100 (hereinafter referred to as the composite hand tool 100) is used to process a cable 200. The composite hand tool 100 includes a pipe 110, an abutting member 130, a driving member 120, and a stopper 140. The pipe 110 includes a pipe body 111 and an annular portion 112 extending from the pipe body 111. The pipe body 111 has an inner space 111e, a first port 111a, a second port 111b, a first window 111c, and a second window 111d. Herein, a first axial direction AX1 and a second axial direction AX2 are defined based on the pipe 110. The first port 111a and the second port 111b are located in the first axial direction AX1, the first window 111c and the second window 111d are located in the second axial direction AX2, and the first axial direction AX1 is different from the second axial direction AX2. As shown in FIG. 3, the first port 111a and the second port 111b are located at opposite ends of the inner space 111e in the first axial direction AX1, and the first window 111c and the second window 111d are opposite to each other with the inner space 111e interposed therebetween in the second axial direction AX2. The first axial direction AX1 is substantially treated as an extension direction of the pipe 111 and is orthogonal to the second axial direction AX2. The first port 111a and the second port 111b are treated as two opposite pipe ports of the pipe body 111.

Further, the abutting member 130 is assembled to the pipe 110 and extends from the first window 111c to the second window 111d. The driving member 120 is movably disposed in the pipe 110 in the first axial direction AX1. The driving member 120 has a blade 122 to move closer to or farther from the abutting member 130 as the driving member 120 moves. The stopper 140 is detachably assembled to the pipe 110 to seal the first port 111a. A first tool 170 and a second tool 180 are disposed on two opposite surfaces of the stopper 140, so that when the stopper 140 is assembled to the pipe 110, one of the first tool 170 and the second tool 180 is hidden in the pipe 110, and the other one of the first tool 170 and the second tool 180 is exposed to an external environment.

Specifically, as shown in FIG. 3, during component installation, the driving member 120 moves from the first port 111a into the inner space 111e of the pipe body 111. Herein, the driving member 120 is formed by a body 121 and the blade 122 embedded therein. The body 121 further has a through hole 121a, and a portion of the blade 122 is exposed at the through hole 121a. After the body 121 is moved into the inner space 111e as described above, the through hole 121a passes through the inner space 111e between the first window 111c and the second window 111d. The abutting member 130 may then be inserted into the pipe body 111 of the pipe 110 through the first window 111c or the second window 111d, the abutting member 130 is also allowed to pass through the through hole 121a and is substantially fixedly connected to the first window 111c and the second window 111d and substantially forms side edge structures of the two windows, and therefore, the through hole 121a communicates with the first window 111c and the second window 111d. In this way, when the abutting member 130 extends from the first window 111c to the first window 111d and passes through the through hole 121a, the movement of the driving member 120 in the inner space 111e may be limited, the driving member 120 may be prevented from falling off the pipe 110, and the blade 122 is opposite to the abutting member 130 and moves closer to or farther from the abutting member 130 as the driving member 120 moves in the first axial direction AX1.

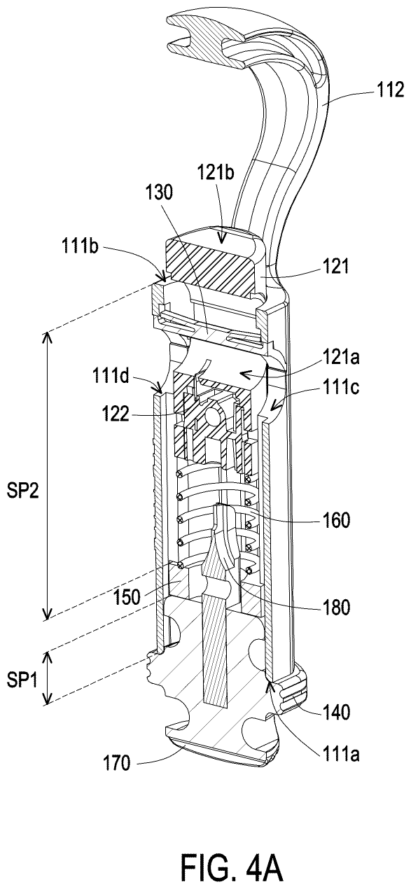

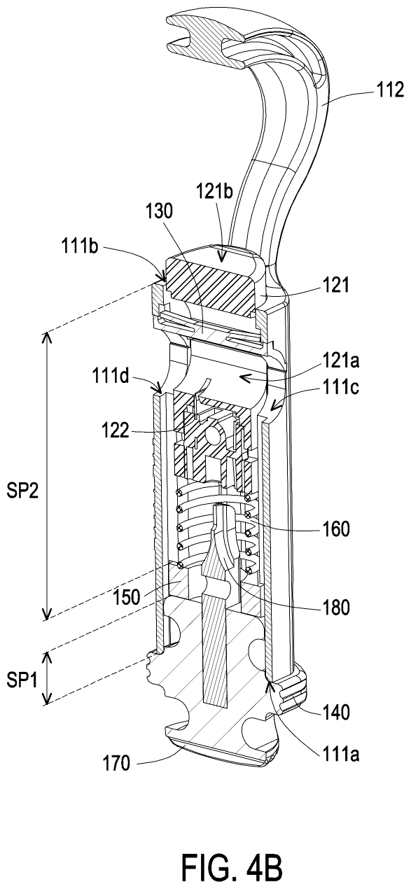

As shown in FIG. 3, the composite hand tool 100 further includes a spring 160 and a spacer 150. Therefore, after the assembly of the driving member 120 and the abutting member 130 is completed, the spring 160, the spacer 150, and the stopper 140 are sequentially installed into the pipe 110. FIG. 4A and FIG. 4B are cross-sectional views illustrating the composite hand tool in different states. With reference to FIG. 3 and FIG. 4A first, in this embodiment, the spacer 150 further divides the inner space 111e into a first subspace SP1 and a second subspace SP2 communicating with each other. The first port 111a and the spacer 150 are located at opposite ends of the first subspace SP1, and the second port 111b and the spacer 150 are located at opposite ends of the second subspace SP2. The driving member 120 and the abutting member 130 are located in the second subspace SP2, and the first window 111c and the second window 111d communicate with the second subspace SP2. The spring 160 is located in the second subspace SP2, abuts between the spacer 150 and the driving member 120, and constantly drives the driving member 120 away from the first port 111a. That is, an elastic force of the spring 160 is used to drive the driving member 120 to move out of the pipe body 111 of the pipe 110 from the second port 111b. Since the abutting member 130 passes through the through hole 121a, the driving member 120 is prevented from being separated from the pipe 110 through the second port 111b.

It can be clearly seen from FIG. 1 to FIG. 3 that a user can decide to use the first tool 170 or the second tool 180 through the stopper 140. As shown in FIG. 4A or FIG. 4B, when the second tool 180 is hidden in the pipe 110, the second tool 180 passes through the spacer 150 from the first subspace SP1 and extends to the second subspace SP2. That is, the spacer 150 and the spring 160 may provide storage space for the longer second tool 180. On the contrary, as shown in FIG. 3, when the first tool 170 is hidden in the pipe 110, the first tool 170 is only located in the first subspace SP1. Based on the above, the pipe 110 provides corresponding storage spaces for different tools, so that multiple tools may be integrated into a single structure.

The processing process of the cable 200 includes three steps: wire stripping, combing, and crimping. The following explains how the composite hand tool 100 is applicable to the above three steps.

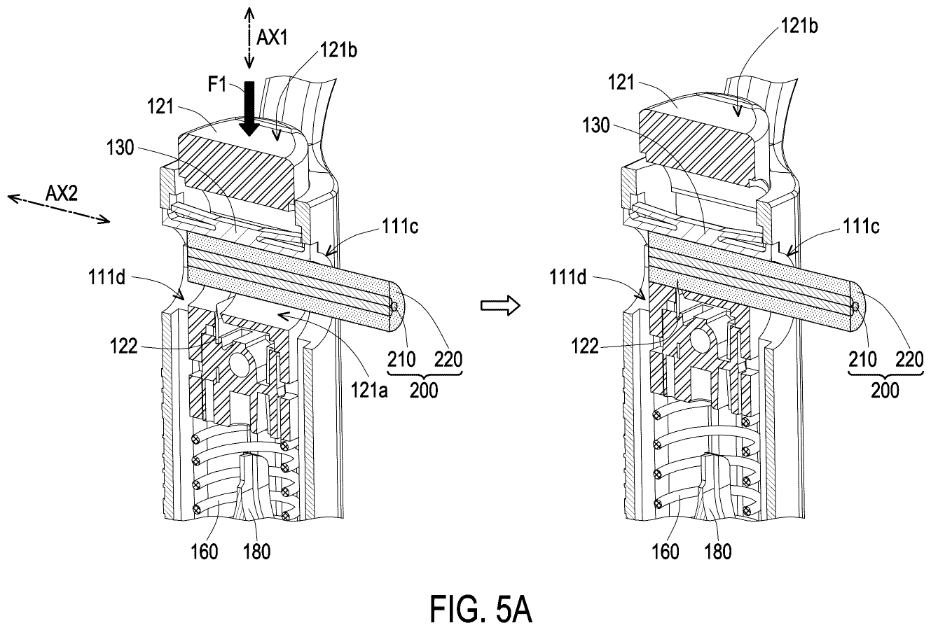

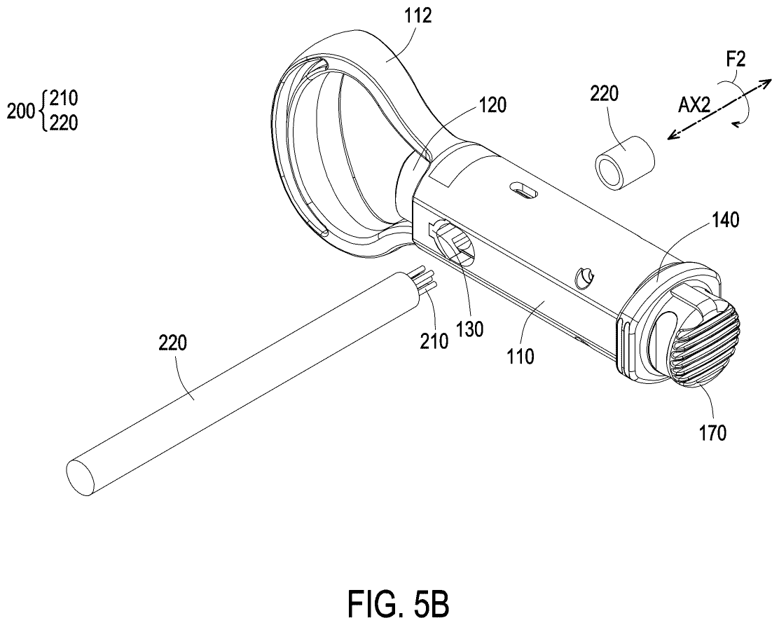

FIG. 5A and FIG. 5B are schematic views illustrating a wire stripping process performed by the composite hand tool. With reference to FIG. 4A, FIG. 4B, and FIG. 5A first, in this embodiment, the body 121 of the driving member 120 further has a pressing side 121b which is exposed through the second port 111b and protrudes out of the pipe body 111 of the pipe 10. The pressing side 121b is adapted to be pressed by an applied force F1 provided by a user, so that the driving member 120 is moved toward the first port 111a and the spring 160 is deformed and accumulates an elastic force, that is, the state is transformed from FIG. 4A to FIG. 4B. The cable 200 may then extend into the through hole 121a from the first window 111c or the second window 111d as shown on the left side of FIG. 5A. Next, the user releases the abovementioned applied force F1, so that the elastic force of the spring 160 drives the driving member 120 to return to its original position, and the cable 200 is clamped between the abutting member 130 and the driving member 120. More importantly, the blade 122 cuts into the insulating outer layer 220 of the cable 200, as shown on the right side of FIG. 5A. Therefore, as shown in FIG. 5B, the user provides an applied force F2 to the composite hand tool 100 to rotate it in the second axial direction AX2, so that the insulating outer layer 220 may be smoothly cut off from the cable 200.

Herein, due to the presence of the annular portion 112, the user may provide the abovementioned applied force F2. For instance, in the state shown in FIG. 5B, the user holds the cable 200 with his/her left hand and passes the fingers of his/her right hand through the annular portion 112 to easily drive the composite hand tool 100 to rotate.

It shall also be noted that the elastic force (or elastic coefficient) of the spring 160 of this embodiment may be adjusted according to needs (e.g., a thickness of the insulating outer layer 220 of the cable 200). In this way, after the user releases the applied force F1, the blade 122 may smoothly cut into the insulating outer layer 220 without damaging core wires 210, and it is convenient to rotate the composite hand tool 100 to perform a circular cutting action on the cable 200.

Accordingly, when a portion of the insulating outer layer 220 is cut off, the plurality of core wires 210 of the cable 200 are exposed. Next, with reference to FIG. 2, the user adjusts the stopper 140 to expose the first tool 170 (the second tool 180 is stored in the pipe 110 herein). The first tool 170 is a combing tool and has a plurality of combing grooves arranged in parallel. Therefore, the user may arrange the multiple wire cores 210 so that they are roughly on the same plane, which is beneficial to the subsequent crimping process.

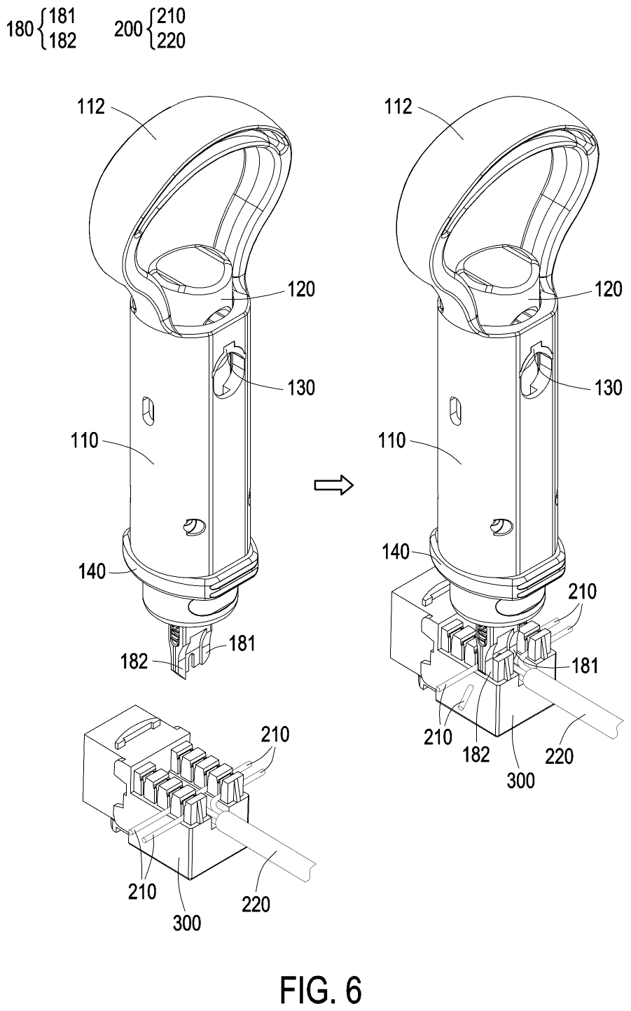

FIG. 6 is a schematic view illustrating a crimping process performed by the composite

hand tool. With reference to FIG. 6, next, the user needs to remove the stopper 140 to expose the second tool 180 to facilitate the crimping process shown in FIG. 6. The second tool 180 includes a crimping head 181 and a blade 182 attached to the crimping head 181. As shown in FIG. 6, after the core wires 210 are combed by the combing tool, the core wires 210 may be arranged roughly on the same plane, so that the core wires 210 may be smoothly placed into the multiple grooves shown in the connector 300. Next, the user may use the second tool 180 of the composite tool 100 to crimp the core wires 210 to the connector 300 one by one, and during the crimping operation, the user may also use the blade 182 to cut off a portion of each core wire 210 protruding from the connector 300.

At this point, the three processes of wire stripping (skinning), combing, and crimping the cable 200 using the composite tool 100 are completed.

In view of the foregoing, in the embodiments of the disclosure, the composite hand tool has ports and windows in different axial directions through the pipe, so that the driving member and the blade are movably disposed in the pipe. The cable can be inserted into the pipe through the windows, so that the blade can cut off the insulating outer layer of the cable. More importantly, one of the ends of the pipe is provided with the stopper, and the stopper may be assembled and disassembled relative to the pipe. Further, different tools are arranged on two opposite surfaces of the stopper, so that when the stopper is assembled to the pipe, one of the tools is stored and the other tool is exposed, so that the user is able to perform operation accordingly. Based on the above arrangement of members, different tools can be integrated into different parts of the pipe, allowing the user to complete wire stripping (skinning), combing, and crimping (including cutting) processes on the cable through a single member and form conversion.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A composite hand tool for wire tooling, comprising:
a pipe having a first port, a second port, a first window, and a second window, wherein the first port and the second port are located in a first axial direction, the first window and the second window are located in a second axial direction, and the first axial direction is different from the second axial direction;
a driving member movably disposed in the pipe in the first axial direction and having a blade; and
a stopper detachably assembled to the pipe to seal the first port, wherein a first tool and a second tool are disposed on two opposite surfaces of the stopper, so that when the stopper is assembled to the pipe, one of the first tool and the second tool is hidden in the pipe, and the other one of the first tool and the second tool is exposed to an external environment,
wherein a cable is adapted to extend into the pipe through the first window or the second window, the blade cuts off an insulating outer layer of the cable to expose a plurality of core wires of the cable, and the core wires are adapted to be combed by the first tool and then crimped to a connector by the second tool.

2. The composite hand tool for wire tooling according to claim 1, further comprising a spacer disposed in the pipe and separating an inner space of the pipe into a first subspace and a second subspace communicating with each other, the first port and the spacer are located at opposite ends of the first subspace, the second port and the spacer are located at opposite ends of the second subspace, the driving member is located in the second subspace, and the first window and the second window communicate with the second subspace.

3. The composite hand tool for wire tooling according to claim 2, wherein when the first tool is hidden in the pipe, the first tool is only located in the first subspace, and when the second tool is hidden in the pipe, the second tool extends from the first subspace through the spacer to the second subspace.

4. The composite hand tool for wire tooling according to claim 2, further comprising an abutting member assembled to the pipe and located in the second subspace.

5. The composite hand tool for wire tooling according to claim 2, further comprising a spring located in the second subspace, abutting between the spacer and the driving member, and constantly driving the driving member away from the first port.

6. The composite hand tool for wire tooling according to claim 5, wherein driving member comprises a body and the blade embedded in the body, the body has a through hole corresponding to and located between the first window and the second window, and a portion of the blade is exposed at the through hole.

7. The composite hand tool for wire tooling according to claim 6, wherein the body has a pressing side exposed outside the pipe through the second port and adapted to be pressed by an applied force provided by a user so that the driving member is moved toward the first port and the spring is deformed, and after the cable extends into the through hole through the first window or the second window, the user releases the applied force, and an elastic force of the spring drives the blade to clamp the cable, wherein the blade cuts into the insulating outer layer.

8. The composite hand tool for wire tooling according to claim 7, further comprising an abutting member assembled to the pipe and located in the through hole, wherein the blade is opposite to the abutting member, and the elastic force of the spring drives the blade to move toward the abutting member to clamp the cable.

9. The composite hand tool for wire tooling according to claim 6, wherein the through hole is connected between the first window and the second window.

10. The composite hand tool for wire tooling according to claim 1, wherein the first tool is a combing tool and has a plurality of combing grooves arranged in parallel to comb the plurality of core wires.

11. The composite hand tool for wire tooling according to claim 1, wherein the second tool is a crimping head with another blade attached, so that when the plurality of core wires are crimped to the connector, the another blade is used to cut off an excess portion of each core wire extending out of the connector.

12. The composite hand tool for wire tooling according to claim 1, wherein the first axial direction is an extension axial direction of the pipe, and the second axial direction is orthogonal to the first axial direction.

13. The composite hand tool for wire tooling according to claim 1, further comprising an abutting member assembled to the pipe and extending from the first window to the second window, wherein the blade moves closer to or farther from the abutting member as the driving member moves, and the cable extending into the pipe is adapted to be clamped by the abutting member and the driving member.
